(19) United States
(12) Patent Application Publication
(10) Pub. No.: US 2004/0103087 A1
(43) Pub. Date: May 27, 2004

(54) Method and apparatus for combining multiple search workers

(76) Inventors: Rajat Mukherjee, San Jose, CA (US); John Wang, San Jose, CA (US); Wei Zhang, San Jose, CA (US); Michel Tourn, Mountain View, CA (US); Kiam Choo, San Francisco, CA (US); Rami Smair, Mountain View, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/305,253

(22) Filed: Nov. 25, 2002

(51) Int. Cl. G06F 7/00

(52) U.S. Cl. 707/3

(57) ABSTRACT

A method of combining information from multiple heterogeneous workers comprises transmitting a first search request to a search worker to assist the search worker in searching a first database and returning a first results set. A second search request is directed to a peer worker to assist the peer worker in initiating a search of a second database across a network asynchronously from the search worker and returning a second results set. The first results set and second results set are then incorporated into a composite results set.

### BRIEF DESCRIPTION OF THE INVENTION

This invention relates generally to search engine technology. More specifically, this invention relates to integrating results received from multiple search workers.

### BACKGROUND OF THE INVENTION

The proliferation of the Internet and large electronic databases has afforded computer users unparalleled access to information. Such access has been aided by the development of search workers, or computer programs capable of searching a database for information relating to a user-specified query. Despite this, much information remains difficult or cumbersome to retrieve. To perform a comprehensive search, users must often peruse several different distributed repositories, each with its own format and search protocols. This has led to the development of heterogeneous search workers, each configured to conform to specific formats and protocols.

Commonly, such heterogeneous search workers are incapable of communicating with each other, requiring users to transmit separate queries to each. This creates difficulties when users are required to search within several different repositories such as multiple portals, multiple enterprise or otherwise proprietary databases, one or more peer networks, and various Internet search services and content providers. One can easily see that a search spanning several of these repositories can require significant effort, often requiring the user to formulate and initiate a separate query for each associated search worker. It is therefore desirable to develop a method of distributing a single query to multiple heterogeneous search workers.

Even in those instances when different search workers are capable of accepting the same query, synchronization problems exist. Variables such as differing database sizes and protocols, as well as various platform speeds, result in different search workers returning results at different times. It is therefore desirable to develop a method of combining heterogeneous search workers in an event-driven fashion, so that search workers have the freedom to operate asynchronously from each other.

An additional shortcoming of many current search workers lies in the sparseness of the results they return. Typical workers search databases and return result sets as lists of documents or other items that satisfy the search query. However, these result sets often contain only limited information, such as the title of a document or a uniform resource locator (URL). If a user requires additional information, such as biographical data on the document's authors or the actual content located at the URL, he or she must undergo additional effort, possibly searching a separate database to find it. It is therefore desirable to develop a method of enhancing results from multiple heterogeneous search workers by specifying and automatically retrieving content that supplements the search results. It is also desirable to perform this enhancement automatically in conjunction with the retrieval of these search results.

Yet another shortcoming of many current search workers stems from the fact that different data repositories frequently utilize different and incompatible formats. As a consequence, result sets from different databases often cannot be meshed together without first translating one or more of them into a different format. Thus, even though users may often wish to view a single list incorporating all the various results of their searches, this typically cannot be done without additional translation effort, if at all.

In view of the foregoing, it would thus be desirable to develop a method of integrating the results from multiple heterogeneous search workers.

### SUMMARY OF THE INVENTION

A method of combining information from multiple heterogeneous workers comprises transmitting a first search request to a search worker to assist the search worker in searching a first database and returning a first results set. A second search request is directed to a peer worker to assist the peer worker in initiating a search of a second database across a network asynchronously from the search worker and returning a second results set. The first results set and second results set are then incorporated into a composite results set.

The method has the advantage of allowing multiple heterogeneous workers to conduct the same search on heterogeneous information repositories. A single search query can thus be transmitted to multiple search workers, which execute the query and return results asynchronously. Automatic modification or enhancement of these results can then be performed as appropriate, and in the same asynchronous manner.

### BRIEF DESCRIPTION OF THE FIGURES

For a better understanding of the nature and objects of the invention, reference should be made to the following detailed description taken in conjunction with the accompanying drawings, in which:

FIG. 1 illustrates a computer network that may be operated in accordance with an embodiment of the present invention.

FIG. 2 illustrates a conceptual representation of workers and modules organized in accordance with an embodiment of the present invention.

FIG. 3 illustrates processing steps associated with an embodiment of the present invention.

FIG. 4A illustrates explicit data enhancement processing steps associated with an embodiment of the present invention.

FIG. 4B illustrates explicit data enhancement processing steps associated with an embodiment of the present invention.

FIG. 5A illustrates implicit data enhancement processing steps associated with an embodiment of the present invention.

FIG. 5B illustrates implicit data enhancement processing steps associated with an embodiment of the present invention.

FIG. 6 illustrates a computer network that may be operated in accordance with an embodiment of the present invention.

Like reference numerals refer to corresponding parts throughout the several views of the drawings.

### DETAILED DESCRIPTION OF THE INVENTION

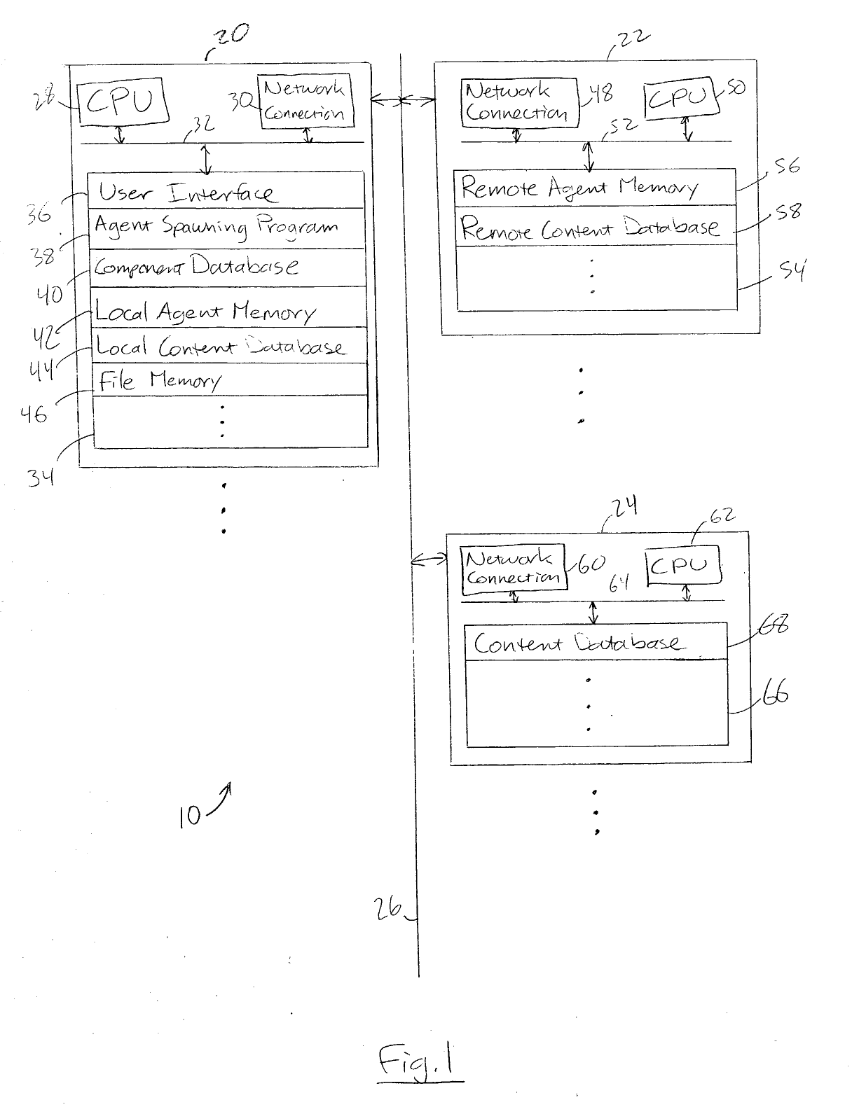

FIG. 1 illustrates a computer network 10 that may be operated in accordance with an embodiment of the present invention. The network 10 includes computers 20, 22, 24, each of which is connected by a transmission channel 26, which may be any wire or wireless transmission channel.

The computer 20 is a standard computer that includes a central processing unit (CPU) 28 for executing instructions and a network connection 30 for communicating across the transmission channel 26. The CPU 28 and network connection 30 are in communication with each other through a bus 32. Also connected to the bus 32 is a memory 34, which can be any computer readable memory. The memory 34 stores a variety of programs and other information for executing instructions in accordance with embodiments of the invention, such as a user interface 36, an agent spawning program 38, component database 40, local agent memory 42, local content database 44, and a file memory 46.

The computer 22 is also a standard computer that includes a network connection 48, CPU 50, and memory 54, each in communication over a bus 52. The memory 54 contains programs and electronic data repositories such as a remote agent memory 56 and a remote content database 58.

Similarly, the computer 24 includes a network connection 60, a CPU 62, and a bus 64 that allows the two to communicate with each other and with a memory 66. The memory 66 also includes a content database 68. It should be noted that the computers 20, 22, 24 of network 10 can be arranged as a client-server network, e.g., with client computer 20 accessing server computers 22 and 24, or it can be arranged as a peer-to-peer network, with each computer 20, 22, 24 operating as a peer of the others.

In operation, users generate a custom search agent by specifying features such as the repositories they would like searched, and various enhancements they wish performed on the results. To that end, users can enter into the user interface 36 the type and configuration of search workers they wish to employ in a search, along with any postprocessing modules for enhancing the results of the search. The user interface 36 then writes the types of search workers and modules (programs configured to search and to enhance the results from search workers in various ways) desired, as well as their configurations, to a file stored in the file memory 46. The agent spawning program 38 reads this file and spawns an agent, or program containing search workers and modules configured accordingly. This new agent is then stored in local agent memory 42.

Once the agent receives a search query, possibly through the user interface 36, its various search workers peruse the databases they are designed to inspect. For instance, content can be stored in a local depository such as the local content database 44. This database is configured to respond to commands in a specific format, which typically requires a specifically-configured search worker. Likewise, a different search worker is configured to access remote databases such as the remote content database 58 on computer 22, which may operate according to differing protocols. Similarly, yet another search worker is configured to execute the search query on a differently-configured content database 68 on computer 24. These search workers can search and return results asynchronously from each other, where they are enhanced by the appropriate enhancement modules.

It should be apparent to one of skill in the art that the various programs of FIG. 1 can be distributed in a variety of ways on the different computers. For example, the programs for spawning an agent can be located on remote computers such as computers 22, 24, while the user interface 36 remains on computer 20. This would allow users to configure and operate an agent that operates on another computer, perhaps within another network that allows access to other databases. Conversely, this would also allow users to assemble a local agent from workers and modules stored remotely. The invention includes this and other configurations for spawning and operating agents, both locally and remotely.

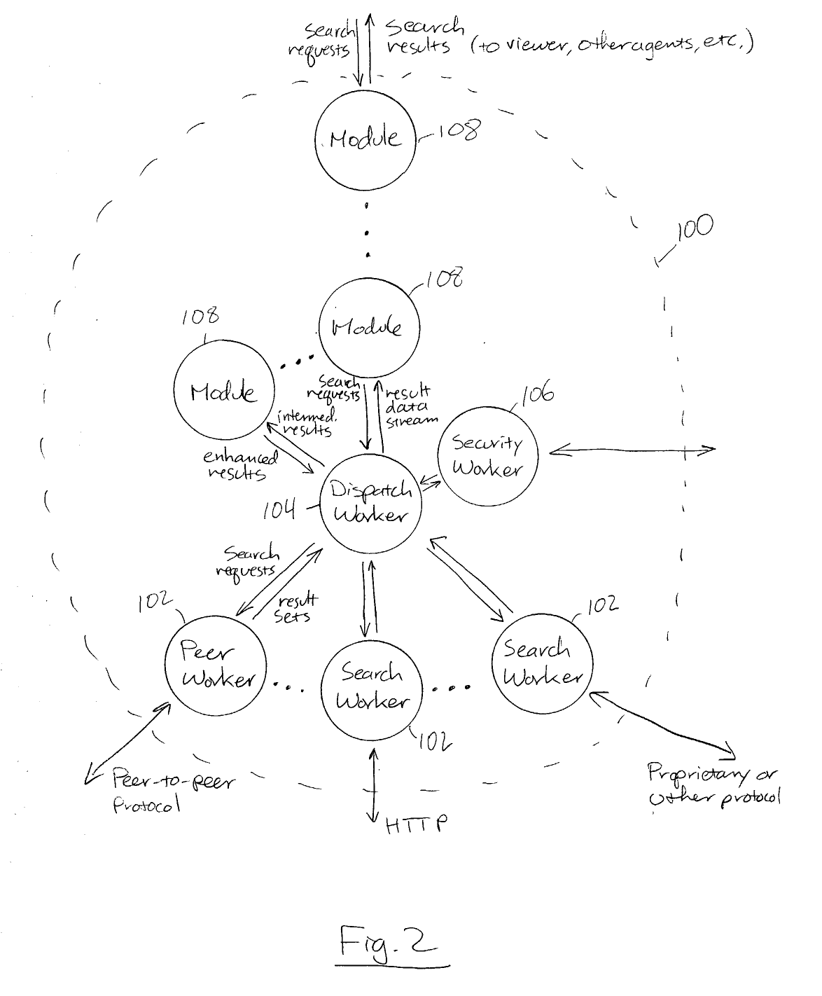

A more complete description of the various enhancements performed is given below, but first an explanation of an embodiment of agents and their workings is given. FIG. 2 illustrates a conceptual representation of such an agent as configured according to an embodiment of the invention. An agent 100 is designed to search multiple heterogeneous databases. Accordingly, it includes a number of search workers 102 for searching, and a dispatch worker 104 for dispatching queries to the search workers 102. The agent 100 also includes a security worker 106 for retrieving authentication information that may be required to search certain databases. In addition, the agent 100 includes a number of modules 108 for performing various enhancement operations on search results. Each search worker 102 and module 108 utilizes the local agent memory 42 to store needed information such as search queries and search results.

In operation, the agent 100 receives search requests as input, and outputs search results responding to these queries. Modules 108 receive the search requests and pass them along to the dispatch worker 104. The dispatch worker 104 then sends each search worker 102 a copy of the search query. Each search worker 102 is configured to receive such a query and act on it by searching certain types of databases. As each worker 102 collects results, it sends them piecemeal as intermediate result sets to the dispatch worker 104, which is configured to perform various enhancement operations such as appending additional information or reorganizing the result sets. The dispatch worker 104 forwards the result sets to other modules 108 for further enhancement, if necessary. The various modules 108 can return intermediate results as processing is completed, or they can store them in local agent memory 42 and present a complete results set when all search workers 102 have completed their searches.

The agent 100 may be pre-defined. Alternately, the workers and modules are designed to facilitate the construction of the agent 100. In this embodiment, the mere act of connecting them in a certain order, such as the structure shown in FIG. 2, specifies the flow of data. To that end, the various workers and modules of the agent 100 are configured as interchangeable and modular pieces of code that can be linked together in numerous ways. Also, workers and modules are designed such that modules pass requests downstream to workers, and workers pass results upstream to the modules for further enhancement. Furthermore, each worker and module is designed to pass information only to specified workers or modules.

In the agent 100 of FIG. 2 for instance, the topmost module 108 is configured to pass search requests only to the module below it. The request thus gets passed from module to module until it reaches the dispatch worker 104, which automatically distributes it to the peer workers 102. Similarly, the peer workers 102 are designed to pass results only to the dispatch worker 104. The dispatch worker 104 automatically acts on the results and passes them to a specific module 108 for processing. Here, the dispatch worker 104 is configured to pass results to the leftmost module 108, which is configured to enhance the results and pass them back to the dispatch worker 104. The enhanced results are then passed to the next module 108, which is designed to conduct further enhancement operations and automatically pass the results up to the next module. Contributing to the asynchronous nature of the agent 100, each module 108 stores results in local agent memory 42, where they can be retrieved as needed. Modules 108 can thus process results piecemeal for future updating as more results are returned. This allows users to view initial results quickly as they are returned, and also allows newer results to be incorporated into the initial results as they arrive. In this manner, modules can present users with an initial list of enhanced results, and can update the list in real time as new results are returned.

In this manner, the act of configuring workers and modules, and linking them in a specific order such as that shown in FIG. 2, automatically and completely specifies the flow of information within an agent 100. This fact, coupled with the automated nature of each worker/module, where each is programmed to automatically perform specific actions in response to a request or result it receives, lends itself to a modular architecture that facilitates the construction of workers/modules that are heterogeneous in nature yet still function together within a single agent.

In one embodiment, each search worker 102 is configured to search according to a specific protocol, and hence is tailored to specific types of databases. For instance, one search worker 102 is shown configured to search Internet-based databases. As such, it is configured to communicate via hypertext transport protocol (HTTP). Similarly, other search workers 102 are designed to issue search requests, and receive results, via proprietary or other protocols, allowing them to search enterprise databases, intranets, private data stores, and the like. Another search worker 102 is specifically designed to search for information within peer-to-peer networks, utilizing peer-to-peer protocols to initiate searches in, and receive results from, various peer computers.

In another embodiment, search workers access client or server databases directly through the use of various protocols, whereas peer workers do not. Because resources on a peer-to-peer network are distributed across several computers and not consolidated in any single database, peer workers themselves do not search an entire peer network. Instead, the peer worker is configured to communicate with a peer agent specially designed to conduct searches over distributed networks. In effect, while other search workers search databases directly, the peer worker of this embodiment can be thought of as a communications worker that acts as an intermediary of sorts, directing another entity (the peer agent) to carry out a search and receiving search results in return.

The heterogeneous capabilities of search workers 102 allow the agent 100 to transmit a single search query across multiple database formats, so as to simultaneously access multiple databases. As an example, the agent 100 would typically reside at the computer 20 that spawned it, where its search workers 102 would allow the agent 100 to access local content database 42 via the appropriate proprietary format. In the meantime, other search workers 102 allow the agent 100 to access Internet-based repositories via HTTP commands, and peer networks via peer-to-peer protocols. Thus, if the content database 68 is accessible over the Internet, various search workers 102 can conduct searches on it. Also, if the computer 24 is an element of a peer network, the peer worker 102 can access its remote content database 58 via a peer-to-peer protocol. Should the peer worker 102 act instead as a communications worker, it would instead communicate with a remote agent located in a remote agent memory 56, whereupon the remote agent would conduct a search of peer databases such as the remote content database 68.

Regardless of the protocol used to conduct a search, each search worker 102 returns search results as they arrive, and within a consistent data structure. The invention in this regard encompasses the use of any data structure appropriate to convey search results. The use of a consistent data structure means that, despite the fact that heterogeneous databases are being searched, results are returned in a homogeneous format. In effect, each search worker acts as a translator of sorts, converting search results from the protocol it is configured to use (e.g., HTTP, peer-to-peer, etc.) into a common language (a consistent data structure). This effective translation simplifies the process of enhancing search results, allowing results from different databases to be rearranged, merged, and incorporated into each other, for instance. In this fashion, the generation of composite results sets that combine search results from multiple heterogeneous sources is greatly facilitated.

Occasionally, the search workers 102 may require authentication information to access secure databases. In such a case, the receiving of a search request can trigger the dispatch worker 104 to query a security worker 106 for appropriate security or authentication information. This information can be stored locally by the worker 106, or it can be accessible remotely, perhaps in a secure memory. The security worker 106 retrieves this information and forwards it to the dispatch worker 104, which then transmits it to the appropriate worker 102 to grant it access to the secure database.

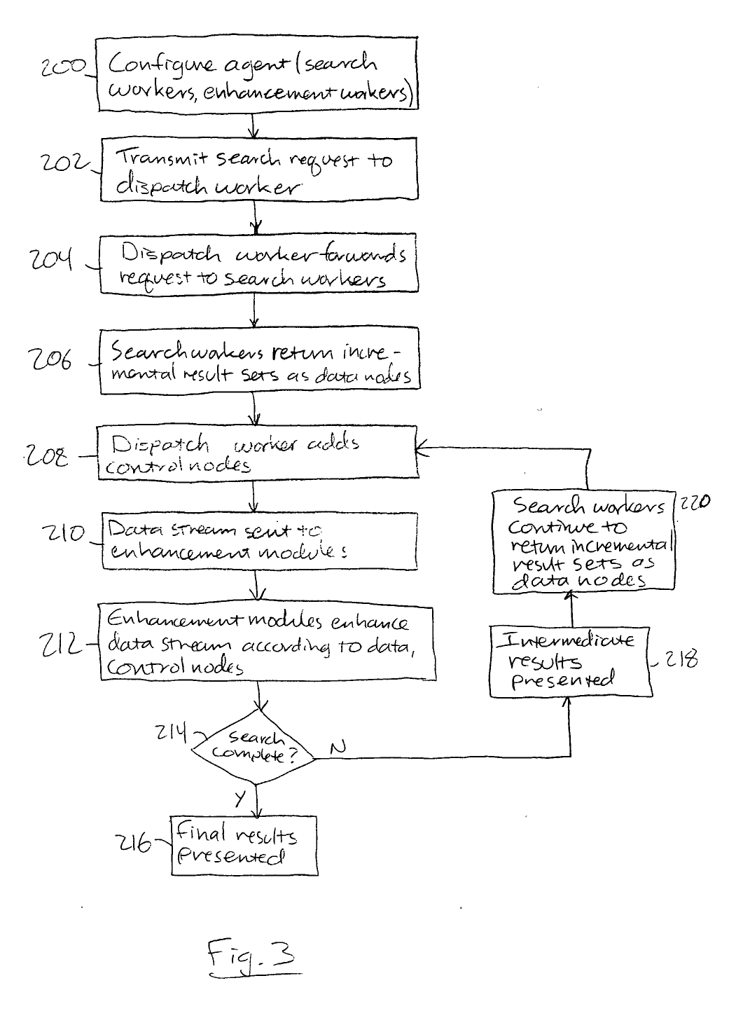

FIG. 3 further illustrates processing steps taken by an agent 100, configured according to an embodiment of the invention, when executing a search request. An agent is first configured (step 200). As above, a user employs a user interface 36 to enter information indicating the search capabilities, as well as any postprocessing of search results, that are desired. This information is then stored in the file memory 46 as a configuration file describing the tree structure of the workers and modules, or how they relate to each other. This tree structure defines the agent 100, and enforces a workflow or data stream: requests flow downward to the workers, and results flow up from the workers through the various modules.

This file is then read by an agent spawning program 38 that stores a modularized set of agent components, such as worker programs and postprocessing modules, in its component database 40. The agent spawning program 38 reads the type of databases the user wishes to search, and retrieves the appropriate worker programs from the component database 40. The spawning program also reads the type of postprocessing requested and retrieves the appropriate postprocessing modules. These modularized workers and modules are then customized according to user input, connected together in the appropriate order, and compiled into an agent that is stored in the local agent memory 42. In one embodiment, instructions detailing the configuration of the agent 100 are written to a configuration file in extensible markup language (XML), while the workers and modules stored in the component database 40 are written in a platform-independent language such as JAVA to allow for maximum compatibility.

Once the agent 100 is configured, compiled, and stored, it is ready to act upon search requests. When a search request is transmitted to the agent 100 (step 202), the various modules 108 transmit it to the dispatch worker 104, which copies the request to each search worker 102 (step 204). The search workers 102 then execute the query, transmitting commands to the appropriate databases via the protocols they are configured to utilize. Often, each search worker does not receive a complete set of results simultaneously. Rather, intermediate result sets trickle in to different search workers 102 at different times. As each of these incremental result sets are returned, they are forwarded to the dispatch worker 104 as data nodes conforming to the aforementioned data structure (step 206).

The incremental result sets are then forwarded to the modules 108 for enhancement. The dispatch worker 104 is configured to receive data nodes, enhance them, and pass them on to specified modules 108 for even further enhancement. Often, the dispatch worker 104 enhances data nodes by appending control nodes instructing other modules 108 to further enhance the data nodes in a specified manner (step 208). The dispatch worker 104 is configured to send results to modules 108 in a specific order. Once it sends the resulting data stream, comprising data nodes and control nodes, to the modules 108 (step 210), the modules 108 parse the data stream, read the control nodes, and perform enhancements as instructed (step 212). In other cases, the modules 108 are not limited to performing enhancements on the explicit instruction of a control node. Rather, it may be desirable for certain modules 108 to automatically enhance any data nodes they see. For instance, in a search for employee names, users may wish for all retrieved names to be returned along with certain biographical information such as addresses, contact information, and the like. Some modules 108 may therefore be configured to automatically access such information whenever a name is detected in the data stream.

If the search is complete, e.g. if all modules have timed out or received an indication that every database has been searched, the final results are presented to the user and resources previously used in searching are freed up for other purposes (step 216). If the search is still ongoing though, those results that do exist are retrieved from the individual modules 108 and are presented as intermediate results (step 218). As results continue to be received, the search workers 102 would then continue to return incremental result sets as data nodes (step 220), and the process would return to step 208 where these incremental result sets would continue to be enhanced and eventually presented to the user.

The search agent 100 can theoretically be maintained for an arbitrary length of time, so as to achieve more complete results by waiting for slow search workers 102 or slow content databases. However, as their operation consumes resources, search agents 100 can be programmed to time out, freeing compute power for other applications. Thus, while the invention includes embodiments capable of conducting long-lasting searches, it also includes embodiments that time out so as to conserve finite computing resources.

One of skill in the art can realize that while the above description relates to an agent executing a single search request, the methods just described can generate agents capable of handling multiple simultaneous search requests. In one embodiment of the invention, each component 102, 104, 108 of agents 100 can be configured to act on search requests that contain an added request identification (ID). If each search request is given a unique request ID, each search worker can transmit the query with the ID appended. When results are returned with this ID attached, the dispatch worker 104 and modules 108 can process them in the usual manner and store the intermediate and final results by ID. In this manner, each agent 100 can process multiple search requests simultaneously, without incurring the delay of waiting for a prior search to complete itself before initiating a subsequent one.

One of skill in the art can also realize that modules 108 need not be limited to presenting results only to users. Instead, modules 108 can be configured to transmit results to other programs for their use. Likewise, results can be transmitted to other agents, perhaps with additional appended instructions, for further enhancement. In this manner, result sets can be greatly supplemented. For instance, the results of a single search initiated at an agent 100 can be transmitted to other agents that can conduct follow-on searches on related topics, or continue the search by perusing databases that the first agent 100 does not have access to.

This latter approach allows searches to be propagated over several different discrete networks, greatly expanding the resources available for users to search. This concept has already been discussed in terms of the peer worker, which in an embodiment described above does not execute searches directly, but acts as a communications worker that transmits results to other agents such as a peer agent. Thus, in the example of FIG. 2, an agent 100 can be equipped with a peer worker that transmits a search request to a peer agent, and a number of search workers 102 that execute the search request directly on specified databases. Additionally, it can be equipped with one or more search workers 102 configured to transmit the search request to other agents for executing the search request on still more databases.

It should also be noted that the above described agents can act on more than just search requests. More specifically, queries can contain worker-specific information that can be used to enhance a search. In this manner, workers can be configured to generate an input parameter, and allow the user to specify its value. The worker can employ the returned value to enhance search results. For instance, the returned value can be used to set the value of a GUI component, thus enhancing the delivery of search results.

The operation of agents 100 has been explained. Accordingly, attention now turns to a description of the various types of enhancement operations that the modules 108 can execute. Typically, search workers 102 query databases for information and return result sets comprising lists of information. For example, a search for documents containing a key word or phrase would return a list comprising the titles, URLs, etc. of documents containing such words or phrases, all arranged in some order. Modules 108 are designed to enhance these result sets in various ways. In this aspect, the invention includes the enhancement of search results by any and all of the following methods.

Initially, it should be observed that result set enhancement is aided by the data structure of the result sets themselves. In one embodiment, result sets are sent within a data stream comprising data nodes, or search results expressed as data elements, and control nodes, or control elements that act as commands. Modules 108 can therefore be programmed to act on the data stream according to at least two methods. The first method analyzes control nodes, while the second relies on the presence of data nodes.

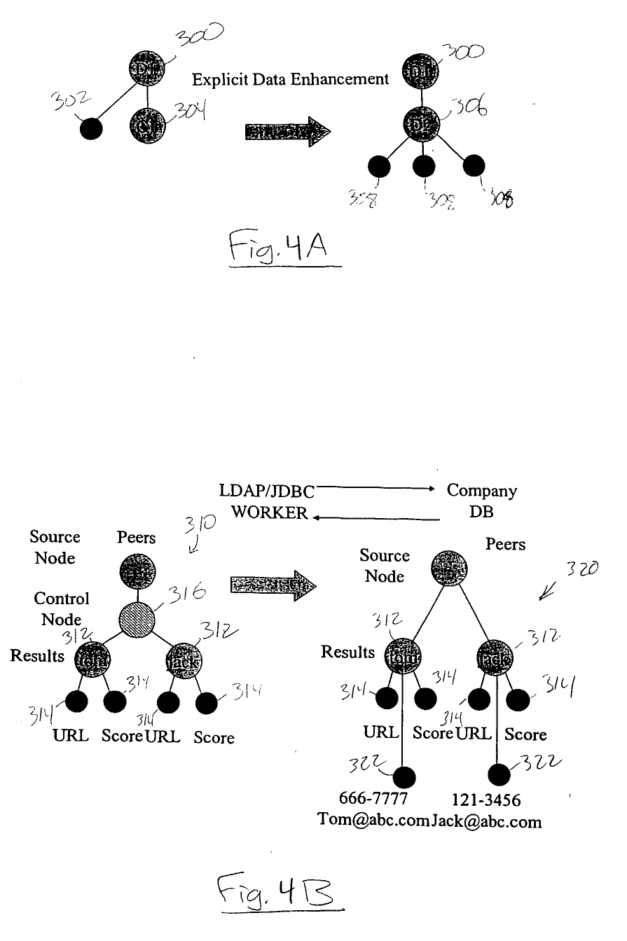

FIG. 4A illustrates processing steps associated with the first method, explicit data enhancement. Here, modules 108 are programmed to explicitly enhance the data stream by following instructions expressly contained within control nodes. For example, a module 108 may receive a data node 300 having an associated search result 302, which is commonly a portion of a search result set such as an individual URL. Appended to the data node 300 is a control node 304. The module 108 acts on the instructions within this control node 304, which instruct it to either replace the control node 304 with other data nodes or replace it with another control node. In this example, the former operation is performed. Specifically, control node 304 is replaced with another data node 306 having associated search results 308. Data node 302 has been removed for purposes of explanation, but can be retained if necessary.

This explicit data enhancement is further explained in the example of FIG. 4B. Here, the data within data stream 310 includes URLs and scores which typically indicate how well each URL matches the search criteria. These URLs and scores are then enhanced with supplementary information to make the data more beneficial to the user. In this example, URLs such as links to articles by a particular author (e.g., when the user is searching for articles by certain authors) are enhanced by appending the authors' telephone numbers and email addresses.

Here, the dispatch worker 104 or another module would construct a data stream that includes data nodes 312 each having search results 314, and a control node 316. The data nodes 312 alert modules 108 to the presence of search results that are contained in appended search results 314, while the control node 316 instructs modules 108 to either replace control node 316 with a different control node containing different instructions, or append additional search results to the data node 312. In this example, the control node 316 instructs a module 108 to read the search results 314, fetch corresponding supplementary information from a specified database, and append it to the data nodes 312 as additional search results 322. More specifically, if the search results include names, the control node 108 instructs a module 108 to read these names, retrieve associated contact information from a specified repository such as an LDAP or JDBC database, and append it to the data nodes 312. To prevent these instructions from being executed again, the control node 316 then directs the module 108 to delete it from the data stream.

As the module 108 must, in this case, retrieve information from an additional database, it resembles a type of worker 102. However, while workers 102 search for information and return data sets to the dispatch worker 104, modules 108 have the additional capability of modifying the data nodes and control nodes of the data stream.

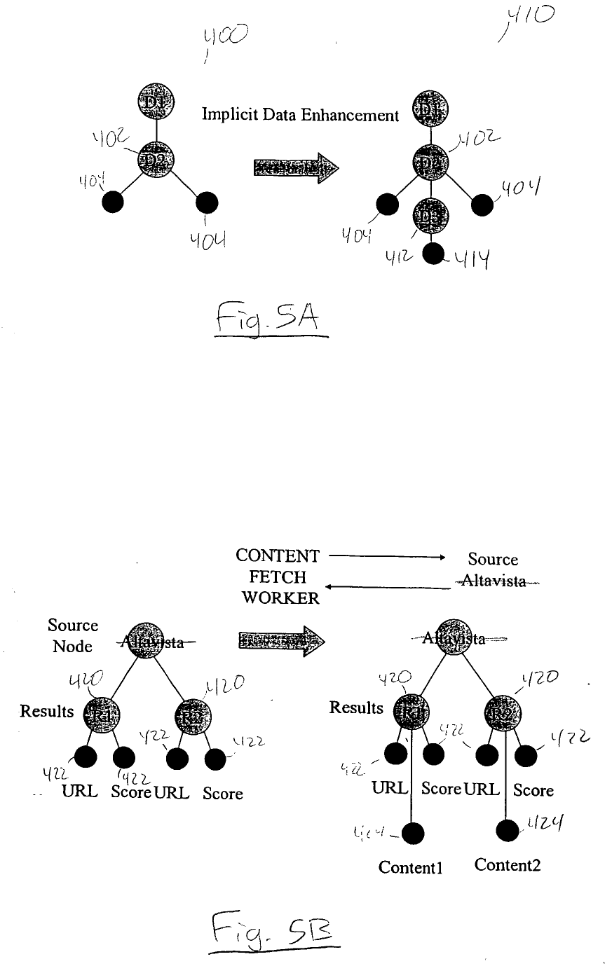

FIG. 5A illustrates processing steps associated with the second method, implicit data enhancement. Here, instead of following explicit instructions contained within a control node, a module 108 automatically enhances any search results it sees within the data stream. In this manner, each search result is also an implicit command directing the module 108 to take certain actions. Thus, if a data stream 400 contains data nodes 402 with search results 404, a module 108 would read the data stream, detect the presence of data nodes 402, and automatically perform an action. Actions taken include appending additional data nodes and/or search results. Here for example, the module 108 has created a modified data stream 410 by detecting the presence of data node 402, searching for additional information, and adding a new data node 412 with an associated supplementary search result 414.

This process is further explained by the example of FIG. 5B. In this example, a user has entered a search query requesting documents satisfying certain criteria. However, the user desires not only the titles and locations of the articles, but their content as well. In this case, workers 102 have executed the search and returned results as indicated by data nodes 420 and their associated search results 422. A module 108 then detects the presence of the data nodes 420, automatically reads the URL search results 422, retrieves the bodies of the articles from those specified locations, and appends them to the data nodes 420 as new search results 424.

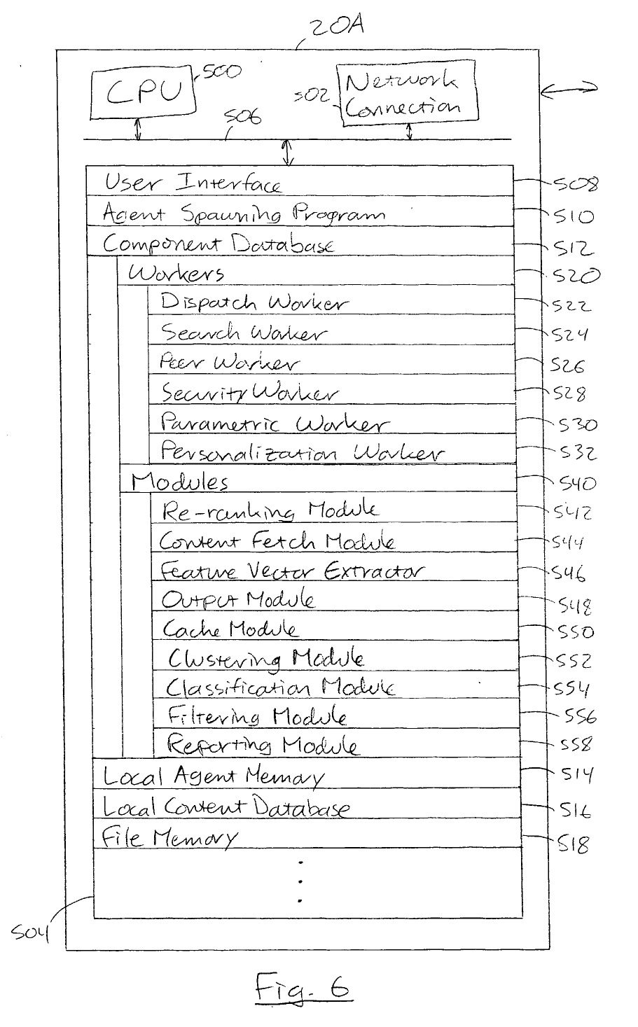

Once search workers 102 retrieve results, the explicit or implicit enhancement of result sets can be utilized to enhance this fetched information in a number of ways. Thus, the invention includes the use of a number of different modules 108. FIG. 6 illustrates a computer configured in accordance with an embodiment of the invention, which stores a number of different workers and modules that can be used in the construction of an agent 100. A computer 20A includes a CPU 500, a network connection 502, and a memory 504, all in communication via a bus 506. The memory 504 stores programs such as a user interface 508, agent spawning program 510, component database 512, local agent memory 514, local content database 516, and file memory 518, each similar in function to the corresponding programs shown in FIG. 1.

The component database 512 stores a number of workers 520 and modules 540, each of which can be designed in modular fashion as described above, so as to facilitate their linking and compiling into an agent 100. As above, each worker and module can be written in JAVA to assist in cross-platform compatibility.

The various modules of FIG. 6 can be employed to enhance search results in a variety of ways. One example is a re-ranking module 542 capable of reordering result sets according to user-defined input. Here, users can specify criteria by which results are to be presented. The re-ranking module 542 then receives data sets from individual workers 102 and reorders the search results accordingly. Another example is a content fetch module 544 designed to read a search result such as a URL, and automatically retrieve the content located at the URL. A third example is a feature vector extractor 546, which typically operates in tandem with a content fetch worker 544. Once a content fetch worker 544 retrieves information and appends it as a data node, the feature vector extractor 546 scans the new data node and appends an additional control node containing a vector of useful/relevant terms summarizing the retrieved content.

The feature vector extractor 546, content fetch module 544, and re-ranking module 542 can be utilized within a single agent 100 to greatly enhance retrieved results. For instance, a search worker may return results comprising a list of documents containing specified words. While these results may be returned in a certain order, such as alphabetically by author, the user may wish for results to be presented in a different order, such as by the frequency with which additional specified words appear. The content fetch module 544 would then be configured to scan the search results for URLs, and automatically retrieve the corresponding documents. This additional information is appended to the search results as data nodes and is passed on to the feature vector extractor 546. The feature vector extractor 546 then reads the data nodes containing the search results and appended documents, and formulates a vector containing frequency information summarizing how often the additional specified terms appear. This vector is appended as a control node and the result set is sent to the re-ranking module 542. The control node instructs the re-ranking module 542 to reorder the result set according to the frequency information it contains.

Recognize that the above described data enhancement presents a significant advantage over search workers that simply retrieve information and present it to users in a single order. The modules described above allow users great flexibility in specifying criteria by which they would like their results presented.

It should also be recognized that many modules can accomplish such enhancements using both implicit and explicit techniques. Here for example, the content fetch module 544 can be configured to detect the presence of data nodes, automatically fetch their associated content, and append it as an additional data node. In this manner, the content fetch module 544 responds to data nodes that act as implied commands directing the module to fetch content. Conversely, the content fetch module 544 can be configured to act on explicit commands only. Thus, a search worker or some other downstream worker or module would formulate the result set as data nodes with an appended control node instructing the content fetch module to retrieve the associated content. The content fetch module 544 would then act in response to the control node, fetching content and appending it as a data node.

In similar fashion, the re-ranking module 542 can operate on implicit or explicit commands. Once the feature vector extractor 546 appends an additional feature vector control node, the re-ranking module 542 can be set to automatically re-rank any data nodes it sees, or it can be programmed to re-rank result sets based on information within the appended vector of features. For instance, the re-ranking module 542 can reorder based solely on information contained within the retrieved results or content (e.g., by author, title, etc.) or the reordering can be based on criteria within the appended feature vector (e.g., by some metric determined by the feature vector extractor, such as the frequency with which certain terms appear).

While the re-ranking module 542 has been described as reordering individual results according to specific criteria such as by frequency of terms or by author, it should be recognized that the invention covers re-ranking modules 542 capable of ordering results in any manner. To that end, the re-ranking module 542 of the invention can rearrange result sets according to criteria other than those mentioned. Furthermore, the re-ranking module 542 can rearrange results according to concept-based retrieval systems such as latent semantic indexing (LSI) methods. The use of LSI methods to retrieve and re-rank results in response to a search query is known in the art.

Another exemplary module is the output module 548. Typically, this module would be the last module to process result sets before they are transmitted out of the agent 100, and as such it translates result sets into a language or format that a user or another program can read. Thus, for example, if a user wishes to view search results using a browser or other user interface 36, the output module 548 would convert result sets into hypertext markup language (HTML) or some other script that a browser can convert to visual information. Similarly, if the result sets are to be passed to another agent for further processing, or on to some other program, the output module 548 could convert the result sets into XML or another language compatible with that program.

A further exemplary module is a cache module 550 configured to store result sets to a cache for long term storage. Such a module would allow important search results to be retained for long periods of time, so as to avoid the need to conduct a second search in case the results of the first were lost or corrupted.

Yet another exemplary module is the clustering module 552. This module clusters, or groups, results according to various criteria such as subject or author. Such a module is useful, for example, when the user desires search results to be grouped according to author, or by the source database they were retrieved from. The clustering module 552 can also be used in tandem with other modules so as to further enhance search results. For instance, the clustering module 552 can pass its results to a re-ranking module 542 when the user desires results grouped according to author, and within each group, re-ranked according to the frequency with which certain keywords appear.

A further exemplary module is the classification module 554. This module can specify a category or class, and categorize results accordingly. For instance, this module can classify incoming results as they arrive, and according to categories (such as by author, date, etc.) that already exist, that the module develops, or that the user is prompted to enter. In the case of a module-developed category, the invention includes the development of categories by any means, empirical, heuristic, or otherwise. In the case of a user-specified category, the classification module 554 can simply contact an external program to query the user and retrieve information on the category or rules desired.

A further exemplary module is the filtering module 556. This module can be used to filter out certain results that the user may wish discarded. For instance, the filtering module 556 can read data nodes, travel to the corresponding URL, and discard the corresponding result if the link is dead or the content is corrupted. The filtering module 556 can also be coupled to other modules to offer further enhancements. In this manner, a filtering module 556 can be paired with a classification module 554 to filter out dead links from categorized search results.

An additional exemplary module comprises a reporting module 558 capable of compiling various search statistics describing various aspects of the search, and reporting these statistics as a portion of the results. In this regard, the invention includes the compiling and reporting of arbitrary statistics. Thus, one embodiment of the reporting module 558 records the number of results from each database (i.e., each search worker 102), so as to allow users to determine which repositories are more valuable to them. Another embodiment includes a report of the number and identity of any dead links. Here, the reporting module 558 typically operates in conjunction with a filtering module 556, compiling statistics on the number and nature of any dead links. Yet another embodiment records the duration of each search and reports search times. The reporting modules 558 of the various embodiments append their statistics as additional data nodes, where they are translated into usable form by an output module.

While the invention includes multiple heterogeneous types of modules, it should be noted that multiple worker types are also included. In addition to the dispatch worker 522, search worker 524, and peer worker 526, which have been described previously, the agent 100 can utilize other workers as well. One previously mentioned example is the security worker 528. When a search worker 524 requires authentication information such as a password to access a restricted database, the security worker 528 is designed to retrieve such information either from a remote storage or from its local memory. In this manner, the agent 100 is capable of repeatedly searching restricted databases without the need for users to input their security information every time a search is to be performed.

Another worker is a parametric worker 530 configured to receive and act on various parameters. For example, the input data stream to an agent 100 can include additional parameters such as a time out duration for ending a search if it fails to return a result within a specified time. Receiving such a time out duration triggers the parametric worker 530 to track the duration of the search. If the specified duration is exceeded, the worker appends a control node signaling the modules 540 to stop work and the dispatch worker 104 to similarly halt the searches of the other workers 520.

A third type of worker is a personalization worker 532 configured to personalize the workings of an agent 100 to the preferences of individual users. In this manner, the agent 100 can configure results according to the user. For instance, users may prefer to view results in an order determined by their user profile, or in a specific format or presentation style. In one embodiment, search queries are received with an appended identifier describing a particular user. The personalization worker 532 then reads result sets to determine the corresponding user, retrieves stored format information corresponding to that identifier, and appends control nodes instructing the output worker to reorganize and/or present results according to a specified format. The output module 548 would then read this control node and further reorder the results as specified. It would then translate the results into HTML script along with additional script describing how a browser should present the search results. This would allow the agent 100 to present search results in the particular arrangement, font, or the like, that the user prefers.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method of combining information from multiple heterogeneous workers, comprising:
transmitting a first search request to a search worker to assist said search worker in searching a first database and returning a first results set;
directing a second search request to a peer worker to assist said peer worker in initiating a search of a second database across a network asynchronously from said search worker and returning a second results set; and
incorporating said first results set and said second results set into a composite results set.

2. The method of claim 1 wherein said transmitting further comprises transmitting said first search request to assist in the returning of a first results set within a data stream including data elements expressing the content of said first data set, and control elements containing instructions for manipulating said data elements.

3. The method of claim 2 further including the steps of retrieving information to supplement one or more of said data elements, and appending said information to said one or more data elements.

4. The method of claim 2 further including the step of replacing one or more of said control elements with one or more of said data elements.

5. The method of claim 2 further including the step of replacing one or more of said control elements with one or more supplementary control elements containing instructions for further manipulating said data elements.

6. The method of claim 1 further including the step of requesting authentication information from a security worker so as to facilitate access to at least one of said first database and said second database.

7. The method of claim 1 wherein said incorporating includes merging said first results set with said second results set.

8. The method of claim 7 wherein said merging includes retrieving supplementary information further detailing said first results set and said second results set, and combining said first results set and said second results set based on said supplementary information.

9. The method of claim 7 wherein said merging includes reordering information within said first results set and said second results set.

10. The method of claim 1 wherein said directing includes directing a second search request to said peer worker to assist said peer worker in initiating a search of a second database within a peer to peer network.

11. The method of claim 1 wherein said transmitting includes relaying said search request to a dispatch worker configured to distribute said search request to said search worker and said peer worker.

12. The method of claim 1 further including the steps of receiving a third results set from said search worker or said peer worker, and incrementally updating said composite results set by combining said third results set and said composite results set.

13. A computer based agent with multiple heterogeneous worker components, comprising:
a search worker configured to receive a search request, conduct a first search according to said search request, and generate a first data set detailing the results of said first search;
a peer worker configured to receive said search request, said communications worker further configured to operate asynchronously from said search worker while transmitting said search request across a network to initiate a second search, and receiving a second data set detailing the results of said second search; and
a module configured to incorporate said first data set and said second data set into a composite data set.

14. The computer based agent of claim 13 further including a security worker configured to retrieve authentication information for obtaining permission to perform at least one of said first search and said second search, and to deliver said authentication information to said search worker and said peer worker.

15. The computer based agent of claim 13 further including a dispatch worker configured to distribute said search request to said search worker and said peer worker.

16. The computer based agent of claim 13 further including a parametric worker configured to modify said first search and said second search according to a specified parameter.

17. The computer based agent of claim 13 wherein said search worker is further configured to communicate said first data set to said module within a data stream including data elements expressing the content of said first data set, and control elements instructing said parent worker to manipulate said data elements.

18. The computer based agent of claim 17 wherein said module is further configured to retrieve information to supplement one or more of said data elements.

19. The computer based agent of claim 17 wherein said module is further configured to replace one or more of said control elements with one or more of said data elements.

20. The computer based agent of claim 17 wherein said module is further configured to replace one or more of said control elements with one or more supplementary control elements containing instructions for further manipulating said data elements.

21. The computer based agent of claim 13 wherein said peer worker is further configured to communicate said second data set to said module within a data stream including data elements expressing the content of said second data set, and control elements instructing said parent worker to manipulate said data elements.

22. The computer based agent of claim 21 wherein said peer worker is further configured to retrieve information to supplement one or more of said data elements, and to append said information to said one or more data elements.

23. The computer based agent of claim 21 wherein said peer worker is further configured to replace one or more of said control elements with one or more of said data elements.

24. The computer based agent of claim 21 wherein said peer worker is further configured to replace one or more of said control elements with one or more supplementary control elements containing instructions for further manipulating said data elements.

25. The computer based agent of claim 13 wherein said peer worker is configured to initiate said second search within a peer to peer network.

26. The computer based agent of claim 13 wherein said module is further configured to combine said first data set and said second data set so as to create said composite data set.

27. The computer based agent of claim 26 wherein said module is further configured to reorder information included within said first data set and said second data set.

28. The computer based agent of claim 13 further including a content fetch module configured to retrieve supplementary information further detailing said first data set and said second data set.

29. The computer based agent of claim 13 further including an output module configured to incorporate said composite data set into instructions written in a computer readable language.

30. The computer based agent of claim 28 further including a personalization worker configured to retrieve format information describing the display of said composite data set, and to instruct said output module to incorporate said composite data set into instructions written according to said format information.

31. The computer based agent of claim 13 further including a cache module configured to store said first data set, said second data set, and said composite data set in a computer memory.

32. The computer based agent of claim 13 further including a clustering module configured to arrange said results of said first search and said results of said second search according to a specified criterion.

33. The computer based agent of claim 13 further including a classification module configured to designate said results of said first search and said results of said second search as belonging to one or more of a category or class.

34. The computer based agent of claim 13 further including a filtering module configured to selectively discard said results of said first search and said results of said second search.

35. The computer based agent of claim 13 further including a reporting module configured to calculate search statistics describing said first search and said second search.

36. The computer based agent of claim 13 wherein said search worker is further configured to receive an input parameter, and to modify said composite data set according to said input parameter.
